(19) United States
(12) Patent Application Publication
(10) Pub. No.: US 2005/0001281 A1
(43) Pub. Date: Jan. 6, 2005

(54) Process to improve image sensor sensitivity

(76) Inventors: Hung-Jen Hsu, Jhonghe City (TW); Chiu-Kung Chang, Jhudong Township (TW); Fu-Tien Wong, Taoyuan City (TW); Te-Fu Tseng, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/858,443

(22) Filed: Jun. 1, 2004

Related U.S. Application Data
(60) Provisional application No. 60/484,718, filed on Jul. 3, 2003.

(51) Int. Cl. G02B 9/00

(52) U.S. Cl. 257/438

(57) ABSTRACT

A packaged image sensing device of improved sensitivity is formed by providing a mechanism for enhancing the focusing of embedded microlenses on the photosensitive elements of the image sensor. Normally, the bonding material interposed between the packaging layers and the microlenses defocuses the microlenses. In one embodiment of the present invention, the focus is restored by interposing an intermediate optically refractive layer between the bonding material and the lenses. In another embodiment, a bonding material with a lower index of refraction is used. In a final embodiment, the microlenses are formed in a material of a higher index of refraction.

### BACKGROUND OF THE INVENTION

1. Field of the Invention

This invention relates generally to image sensors and packaging methods thereof. In particular, it relates to the formation of either a CMOS (CIS) or charge-coupled device (CCD) packaged image sensor having embedded microlenses and improved sensitivity as a result of a novel packaging process.

2. Description of the Related Art

Solid state image sensors are necessary components in many optoelectronic devices, including digital cameras, cellular phones, and toys. In the simplest possible terms, such a sensor consists of an array of photosensors (eg. photodiodes), connected to solid state devices that convert the signals generated by the photosensors (typically electrical charge) into forms that can be displayed electronically. Two types of signal converting solid state devices in common use are charge-coupled devices (CCDs) and CMOS image sensors (CISs). In order for these devices to operate at optimal levels, the light from the image being sensed must be focused on the photosensors and any transmission loss along the optical pathway between the entrant surface of the device and the photosensors must be minimized. Potential focusing problems can be solved by the formation of small lens structures (microlenses) above the photosensors. These lenses are embedded within the sensing structure and are formed by photolithography techniques followed by melting or reflowing photoresist squares into hemispheres. The transmission loss problem is addressed by the use of transparent bonding materials (epoxies) and glass (or other transparent media) as connective, filtering, and protective layers.

Examples of various forms of the solid state sensor structures are to be found in the prior art. Okamoto (U.S. Pat. No. 6,545,304 B2) discloses a photoelectric converter element group on one section of a semiconductor substrate and a charge transfer path to transfer accumulated signal charge to a contiguous readout gate region having a readout gate electrode associated therewith. Umetsu et al. (U.S. Pat. No. 6,528,831 B2) discloses a solid state image pickup device in which a matrix array of photoelectric sensors are formed adjacent to charge transfer channels and wherein a read-cum-transfer electrode is formed on an insulating layer and surrounds each photoelectric element. These devices are cited here as examples of a CCD type sensor device.

Methods of enhancing the transmission of light to the active elements of the sensing device are also to be found in the prior art. Teranishi et al. (U.S. Pat. No. 5,844,289) discloses a solid state image sensor incorporating surface microlenses with attached optical fiber-bundles. Abramovich (U.S. Pat. No. 6,362,498 B2) discloses a color CMOS image sensor with microlenses formed in a silicon nitride layer by reactive ion etching (RIE).

Before solid state image sensors can be incorporated within target technologies (digital cameras, phones etc.), they must be properly packaged. Packaging serves several purposes critical to the commercial use of image sensors in various target technologies. Packaging protects delicate solid state elements, it provides a suitable and stable configuration for interfacing with various shapes and designs of target technologies and provides easily accessible electrical interconnects that enable the sensors to be conveniently incorporated within a wide variety of such technologies. The beneficial electrical and mechanical attributes of packaging can, however, adversely impact the required optical properties of the image sensors. The present inventors utilize a particular commercially available packaging technology (manufactured and offered for sale by Shellcase corp.), but the problems to be discussed herein would clearly be associated with other packaging methodologies. In particular, as shown schematically in prior art FIG. 1, the packaged image sensor (Shellcase package) is a glass-silicon-glass laminate. Referring to FIG. 1, there is shown a (prior art) commercially packaged image sensing fabrication of the type which is the subject of the present application. The fabrication comprises an upper glass layer (10) and a lower glass layer (20) that sandwiches an optically and electronically active silicon layer (90) which may advantageously be substantially an entire wafer (comprising, thereby, what is called “wafer level chip scale packaging,” WLCSP). The lower glass layer (20) supports a plurality of solder connectors (39) for connection, by melting and re-solidifying, to external circuitry which is not a part of the device. The solder connectors (39) are internally connected (eg. by wires through the glass layer) to the solid state circuitry of the image sensing device (90) which is integrated on a silicon layer. The silicon layer has an upper surface portion (101) which includes an optically sensitive region containing a matrix array of photodiodes covered by an array of embedded microlenses (30) which are shown schematically and greatly enlarged as small convex “bumps”. A layer of filtering material (not shown) may be formed between the microlenses (30) and the photodiodes. The optically and electronically active silicon layer (90) is bonded above (70) and below (80) by a transparent bonding agent (typically, epoxy) to both glass layers (10, 20). Although the bonding agent is kept to a minimum thickness consistent with requirements of structural integrity, it causes an inevitable degradation of the optical signal impinging on and propagating within the optically sensitive region. The degradation is a result of both absorption of the radiation and defocusing of the light by the microlenses (30) because of mismatching of the indices of refraction of the epoxy bonding agent (typically n_{B}=1.5) and the material of the lenses (typically n_{L}=1.63). Although the radius of curvature of the microlens can be adjusted to shorten the focal length, this method has process and physical limits. The focal length of the microlens is typically shortened by increasing the thickness of the photoresist film to obtain a smaller radius. The thickness of the photoresist film is controlled by rotation rate while spin coating, and the rotation rate cannot too slow due to uniformity of the photoresist film. The object of the present invention is to improve sensor sensitivity by restoring the focus of the microlenses onto the optically sensitive region while still retaining the advantages of packaging.

### SUMMARY OF THE INVENTION

Accordingly, it is the object of this invention to provide a packaged image sensor with improved image sensitivity.

This object will be achieved within the context of commercially available packages and packaging technology that are known to be advantageously applied at the wafer level chip scale (WLCSP). In particular three embodiments will be presented. In the first embodiment a special intermediate optically refractive layer will be interposed between the epoxy bonding layer and the microlens. The index of refraction, n_{I}, of this layer will compensate for the defocusing of the incident radiation which results from the index of refraction of the epoxy layer combined with the index of refraction of the lens structure. In the second embodiment, an epoxy with a lower index of refraction will be used as the bonding agent, thus achieving the same end without the use of an additional layer. In a third embodiment, the microlens will be formed in a layer having a greater index of refraction (n>1.7).

### BRIEF DESCRIPTION OF THE DRAWINGS

FIG. 1 shows a schematic cross-sectional view of a commercially packaged image sensor in accordance with the prior art.

FIG. 2 shows a detail of a prior art unpackaged image sensor wherein the lens and filter layer combine to produce correctly focused radiation.

FIG. 3 shows a detail of the packaged prior art sensor of FIG. 1, illustrating the defocusing of the incident radiation by a bonding material.

FIG. 4 shows a detail of a first embodiment of the present invention, in which an additional layer is interposed between the packaging epoxy and the microlens.

FIG. 5 shows a detail of a second embodiment of the present invention, in which an epoxy layer of lower index of refraction is used.

FIG. 6 shows a detail of a third embodiment of the present invention, in which the microlens is formed in a higher index of refraction material layer.

FIG. 7 shows the optical conditions for optimization of packaged image sensor.

### DETAILED DESCRIPTION OF THE INVENTION

The preferred embodiments of the present invention each teach a method of forming a packaged image sensor so that elements of the packaging structure, such as bonding materials, do not adversely affect the optical performance and sensitivity of the sensor. Of particular concern in the fabrication of image sensors is the focusing of incident radiation on the photosensitive elements of the sensors. Referring to FIG. 2, there is shown a cross-sectional schematic view of portion of a prior art image sensor. A series of lines (20) represent the optical path of rays of incident radiation. The rays pass through air (index of refraction, n_{A}=1) and are incident as an essentially parallel bundle on an optically receptive stacked layer (35) which is formed on the upper surface (101) of the semiconductor substrate (100). An upper portion of the optically receptive stacked layer (35) includes a convex (converging) microlens (30) which is formed, typically by coating a microlens photoresist, patterning the microlens photoresist to form an array of microlens pattern, and heating (for example using a hot plate and maintain the temperature at about 160° C.) the patterned photoresist to induce thermal reflow. The convex microlens (30) having an index of refraction, n_{L}, where n_{L}=1.63 is formed as a result of surface tension. Similarly, if the photopattern is striped, the reflow results in forming hemi-cylindrical lenses. The microlens (30) is in contact with a transparent color filter layer (40) whose index of refraction is n_{CF}=1.51 and thickness is about 2-6 μm. The radius of curvature of the microlens (30) is about 0.5-20 μm, 1-8 μm is preferred. The color filter layer (40) is in contact with an IC stacked layer (50) also of index of refraction n_{IC}=1.51 and thickness of about 2-12 μm which depend on IC design and process. The IC stacked layer (50) comprises passivation layer, inter-metal dielectric layers (IMDs), inter-layer dielectric layer (ILD), metal lines, transistors, junctions and other electric elements. The metal lines shield light, therefore, the light-shielding structures are disposed between pixel boundaries. As shown in the figure, the ray bundle is caused to converge (24) by the surface curvature of the microlens (30) combined with its index of refraction n_{L} and, in accord with the radius of curvature of the lens surface and the indices of refraction of the layers (40), (50) beneath the lens, the rays converge to focus on photosensitive elements (60) disposed on the surface of the semiconductor substrate (100). The photosensitive elements (60) are typically further coupled to integrated device structures within the image sensor, such as charge-coupled devices or CMOS circuitry, which convert the output of the photosensors to electrical signals that can be advantageously used by the target technology which incorporates the image sensor. This associated circuitry is not shown as it is not relevant to the nature of the invention. The present invention does not relate to the particular nature of the signal processing within the image sensor, but only to the optical processes acting on the incident radiation as it travels to the photosensors.

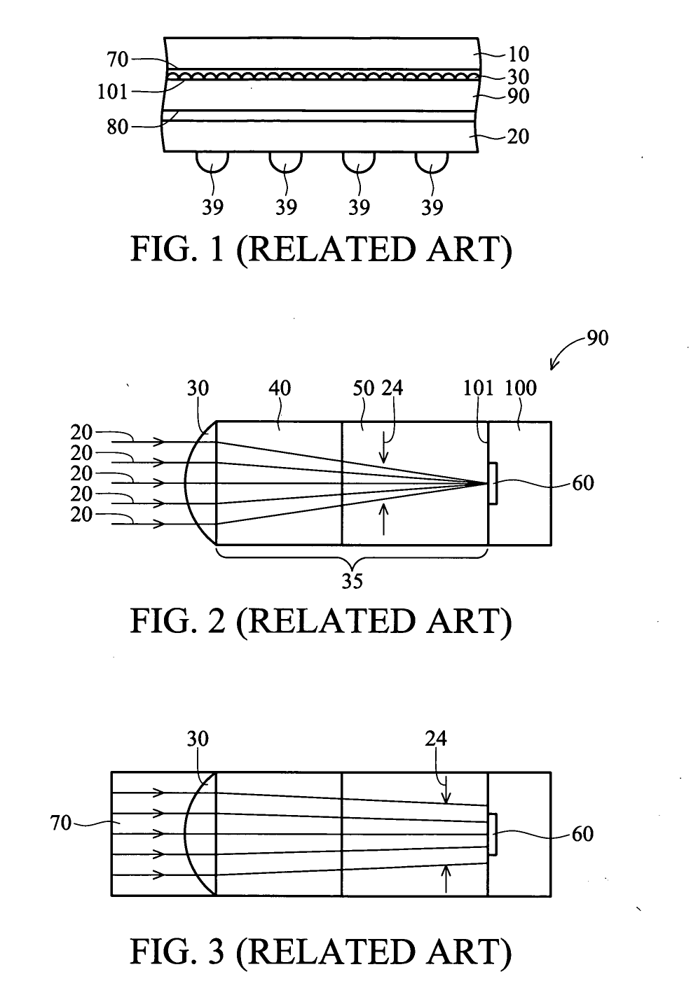

Referring next to FIG. 3, there is shown a cross-sectional schematic illustration of the optical effects of a bonding layer of epoxy (70) with nB=1.5 which is used to bond the sensing device (90) of FIG. 2 within a package such as that shown in FIG. 1 using methods of the prior art. The addition of an epoxy layer with index of refraction different from that of the air in FIG. 2, destroys the convergence of the ray bundles (24) and degrades the signal reaching the photosensitive elements (60). The radius of curvature of the microlens (30) cannot be sufficiently reduced to focus incident radiation on the photosensitive elements (60), because of process and physical limits.

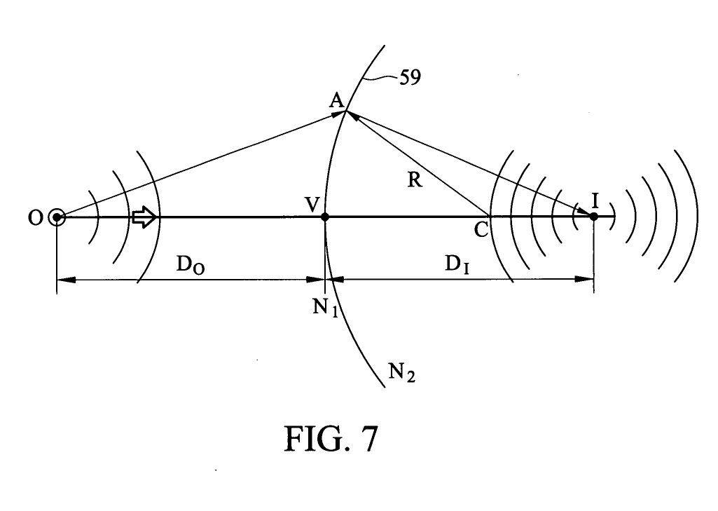

FIG. 7 depicts the spherical boundary surface of a microlens (59) radius R centered at point C. An object or point light source O at an object distance D_{O} from the vertex V along the axis of the microlens will refractively converge a cone of light rays to an image at image distance D_{I} from point V. If the index of refraction in the space between the object light source O and the spherical boundary surface (59) of the microlens is N₁ and the index in the space inside the lens (to the right of the spherical lens surface in FIG. 7) is N₂, then spherical wavefronts will converge to a real image at I. Using the well-known Fermat's Principle, it can be shown that for spherical refracting surfaces:
N₁/D_{O}+N₂/D_{I}=(N₂−N₁)/R
and, that when D_{O} is very large, the image focal length is then given by:
Fᵢ=R(N₂/N₂−N₁).

For fixed Fᵢ and N₂, we can have a series of optimal R and N₁. In real situation, the process limits the radius of curvature R.

Specifically, if N₂=1.63, N₁=1 (air), for Fᵢ=12 μm, R=4.63 μm is chosen.

If N₂=1.63, N₁=1.5 (epoxy), for Fᵢ=12 μm, R=4.63 μm is not suitable and R=0.95 μm should be chosen, however, it is hard to control. When R>1.5 μm, the process can be easily controlled and the microlens can achieve better uniformity.

If N₂=1.63, Fᵢ=12, R>1.5 μm, N₂−N₁ greater than 0.2 is suitable for an image sensor with better sensitivity. In real situation, the focal length Fᵢ may be around 12 μm, for example, 11 μm or above 12 μm, because packaged image sensors are trending toward small areas for embedding within optoelectronic devices, such as digital cameras, cellular phones, toys, or watches.

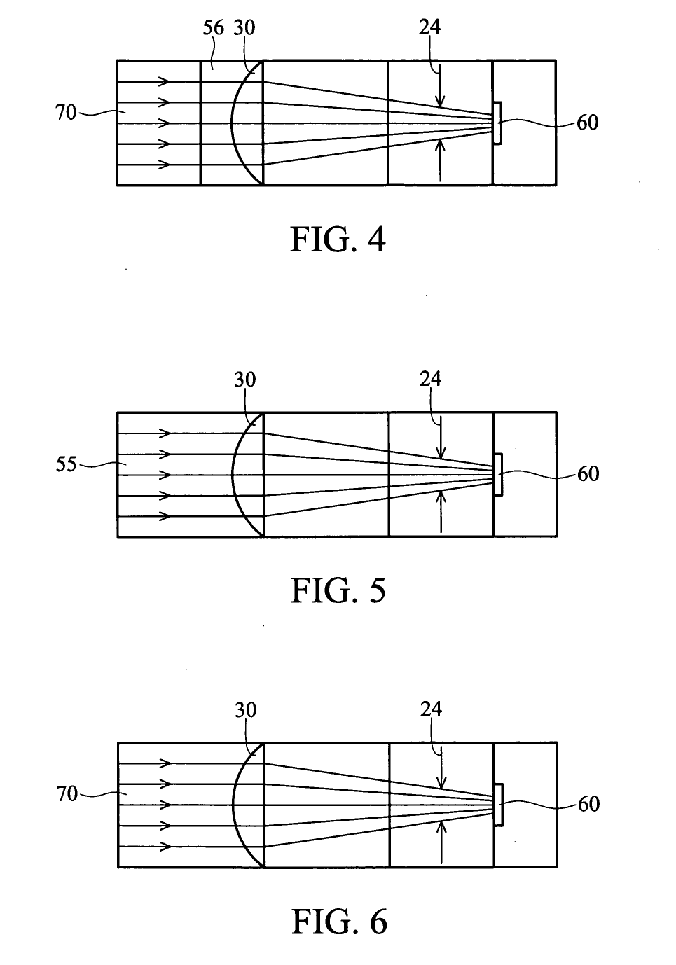

Referring next to FIG. 4, the packaging method of the first embodiment of the present invention is shown, wherein an additional intermediate optically refractive layer (56) with n_{I}<n_{B} is formed between the microlens (30) and the bonding layer (70). For example, while the bonding layer of epoxy has nB=1.5, the additional intermediate optically refractive layer (56) has n_{I}<1.5, where n_{I} between approximately 1.33 and 1.45 is preferred. This additional intermediate optically refractive layer (56) has the characteristics of high transmittance (>90%, greater than 95% is preferred), thermal resistance, chemical resistance and viscosity greater than 5 mpas (greater than 10 mpas is preferred), and can be a layer of material such as [A] a mixture including Fluororesin derivative, Initatoe, Methylisobutylketone (MIBK), and t-butanol, or [B] a mixture including Fluororesin derivative, Initatoe, Melamine resin, Methylisobutylketone (MIBK), t-butanol, formed to a thickness higher than microlens (30), approximately greater than 0.5 μm, 1 μm is preferred. The convergence of the ray bundles (24) is restored by the interposition of this additional intermediate optically refractive layer (56).

Alternatively, the additional intermediate optically refractive layer (56) satisfies the condition of n_{L}−n_{I} greater than 0.2.

Referring next to FIG. 5, there is shown in cross-sectional schematic form, a second embodiment of the present invention wherein an epoxy layer (55) with an index of refraction less than 1.5 (eg. n_{B}=between approximately 1.33 and 1.45 being preferred) is used to bond the sensor within the package. The use of a lower index of refraction epoxy eliminates the need for the additional intermediate layer (56) used in the first embodiment yet also restores the convergence of the ray bundles (24). In this case, the epoxy layer (55) satisfies the condition of n_{L}−n_{B} greater than 0.2 to focus incident radiation on the photosensitive elements (60). For example, the index of refraction n_{L} of the microlenses equals approximately 1.63, and the epoxy layer (55) has an index of refraction n_{B} which is between approximately 1.33 and 1.45. The epoxy layer (55) can be a transparent material such as organopolysiloxane mixture with n_{B}=1.4.

Referring finally to FIG. 6, there is shown in cross-sectional schematic form, a third embodiment of the present invention wherein the microlens (30) is now formed of a transparent material having an index of refraction n_{L} satisfying n_{L}−n_{B} greater than 0.2. For example, the epoxy layer (70) has an index of refraction n_{B} approximately 1.5, and the index of refraction n_{L} of the microlenses (30) is greater than 1.7, with a range between 1.73 and 1.8 being preferred.

As is understood by a person skilled in the art, the preferred embodiments of the present invention are illustrative of the present invention rather than limiting of the present invention. Revisions and modifications may be made to methods, materials, structures and dimensions employed in fabricating a packaged image sensor having improved sensitivity, while still providing such a packaged image sensor having improved sensitivity as described herein, in accord with the spirit and scope of the present invention as defined by the appended claims.

1. A packaged image sensor with improved sensitivity comprising:
a semiconductor substrate having an upper and a lower surface, a plurality of photosensitive elements being disposed on the upper surface, an optically receptive stacked layer formed on the upper surface, the optically receptive stacked layer comprising a lens layer of material having an index of refraction n_{L}, which is formed into a layer of converging microlenses and further comprising optical layers disposed between the microlenses and the upper surface;
an intermediate optically refractive layer of index of refraction n_{I} and thickness t_{I} formed on the microlenses, a lower surface of the intermediate layer being conformally in contact with the microlenses and an upper surface of the layer being planar;
optically transparent packaging layers formed above the intermediate optically refractive layer and below the lower surface of the semiconductor substrate; and
the packaging layers being bonded to the intermediate optically refractive layer and to the lower surface of the semiconductor substrate by a transparent bonding material interposed between the packaging layers and the intermediate layer and the lower surface, the bonding material having an index of refraction n_{B}.

2. The packaged image sensor of claim 1, wherein the thickness t_{I} and the index of refraction n_{I} of the intermediate optically refractive layer are chosen so that the microlenses focus incident radiation on the photosensitive elements, thereby improving the sensitivity of the sensor.

3. The packaged image sensor of claim 2, wherein the intermediate optically refractive layer has the thickness, t_{I}, higher than that of the microlens and has the index of refraction, n_{I}, smaller than the index of refraction, n_{B}, of the bonding material.

4. The packaged image sensor of claim 3, wherein the intermediate optically refractive layer has the thickness, t_{I}, greater than 0.5 μm.

5. The packaged image sensor of claim 3, wherein the bonding material is an epoxy with an index of refraction n_{B} which equals approximately 1.5.

6. The packaged image sensor of claim 5, wherein the intermediate optically refractive layer has the index of refraction, n_{I}, between approximately 1.33 and 1.5.

7. The packaged image sensor of claim 6, wherein the intermediate optically refractive layer is a layer of a mixture including Fluororesin derivative, Initatoe, Methylisobutylketone (MIBK) and t-butanol or a mixture including Fluororesin derivative, Initatoe, Melamine resin, Methylisobutylketone (MIBK), and t-butanol.

8. The packaged image sensor of claim 6, wherein the microlenses have radius of curvature between approximately 0.5 and 20 μm.

9. The packaged image sensor of claim 6, wherein the microlenses have the index of refraction n_{L} which equals approximately 1.63.

10. The packaged image sensor of claim 11, wherein the optical layers comprises a transparent color filter layer and an IC stacked layer between the transparent color filter layer and the upper surface of the semiconductor substrate, the transparent color filter layer has a thickness between approximately 2 and 6 μm and an index of refraction n_{CF} approximately 1.51, and the IC stacked layer has a thickness between approximately 2 and 12 μm and an index of refraction n_{IC} approximately 1.51.

11. The packaged image sensor of claim 1, wherein the thickness t_{I} and the index of refraction n_{I} of the intermediate optically refractive layer are chosen to shorten the focal length so that the microlenses focus incident radiation on the photosensitive elements.

12. The packaged image sensor of claim 11, wherein a difference between the index of refraction n_{L} of the microlenses and the index of refraction n_{I} of the intermediate optically refractive layer, n_{L}−n_{I}, is greater than 0.2.

13. The packaged image sensor of claim 12, wherein the intermediate optically refractive layer has the thickness, t_{I}, higher than that of the microlens.

14. The packaged image sensor of claim 13, wherein the intermediate optically refractive layer has the thickness, t_{I}, greater than 0.5 μm.

15. The packaged image sensor of claim 14, wherein the bonding material is an epoxy with an index of refraction n_{B} which equals approximately 1.5.

16. The packaged image sensor of claim 15, wherein the intermediate optically refractive layer has the index of refraction, n_{I}, between approximately 1.33 and 1.5.

17. The packaged image sensor of claim 16, wherein the intermediate optically refractive layer is a layer of a mixture including Fluororesin derivative, Initatoe, Methylisobutylketone (MIBK) and t-butanol or a mixture including Fluororesin derivative, Initatoe, Melamine resin, Methylisobutylketone (MIBK), and t-butanol.

18. The packaged image sensor of claim 16, wherein the microlenses have radius of curvature between approximately 0.5 and 20 μm.

19. The packaged image sensor of claim 16, wherein the microlenses have the index of refraction n_{L} which equals approximately 1.63.

20. The packaged image sensor of claim 19, wherein the optical layers comprise a transparent color filter layer and an IC stacked layer between the transparent color filter layer and the upper surface of the semiconductor substrate, the transparent color filter layer has a thickness between approximately 2 and 6 μm and an index of refraction n_{CF} approximately 1.51, and the IC stacked layer has a thickness between approximately 2 and 12 μm and an index of refraction n_{IC} approximately 1.51.

21. The packaged image sensor of claim 1, further comprising a plurality of solder connectors disposed on the packaging layer bonding to the lower surface of the semiconductor substrate and opposite to the semiconductor substrate, the solder connectors being connected between the packaged image sensor and an external circuitry.

22. A device comprising a packaged image sensor of claim 1 embedded therein.

23. The device of claim 22, wherein the device is a cellular phone, digital camera or a toy.

24. A packaged image sensor with improved sensitivity comprising:
a semiconductor substrate having an upper and a lower surface, a plurality of photosensitive elements being disposed on the upper surface, the photosensitive elements being capable of converting incident radiation to electrical signals;
an optically receptive stacked layer formed on the upper surface, the optically receptive stacked layer comprising a lens layer of material having an index of refraction n_{L}, which is formed into a layer of converging microlenses and further comprising optical layers disposed between the microlenses and the upper surface;
optically transparent packaging layers formed above the microlenses and below the lower surface of the sensing device; and
the packaging layers being bonded to the microlenses and to the lower surface by a transparent bonding material interposed between the packaging layers and the microlenses and the lower surface of the semiconductor substrate, the bonding material having an index of refraction n_{B}, a difference between the index of refraction n_{L} of the microlenses and the index of refraction n_{B} of the bonding material, n_{L}−n_{B}, being greater than 0.2 to focus incident radiation on the photosensitive elements.

25. The packaged image sensor of claim 24, wherein the index of refraction n_{L} of the microlenses equals approximately 1.63.

26. The packaged image sensor of claim 25, wherein the bonding material is an epoxy with an index of refraction n_{B} which is between approximately 1.33 and 1.45.

27. The packaged image sensor of claim 24, wherein the bonding material is an epoxy having an index of refraction n_{B} approximately 1.5.

28. The packaged image sensor of claim 27, wherein the index of refraction n_{L} of the microlenses is between approximately 1.73 and 1.8.

29. The packaged image sensor of claim 24, further comprising a plurality of solder connectors disposed on the packaging layer bonding to the lower surface of the semiconductor substrate and the surface opposite to the semiconductor substrate, the solder connectors being connected between the packaged image sensor and an external circuitry.

30. A device comprising a packaged image sensor of claim 24 embedded therein.

31. The device of claim 30, wherein the device is a cellular phone, digital camera or toy.

32. A packaged image sensor with improved sensitivity comprising:
an image sensor including
a semiconductor substrate having an upper surface and a lower surface, a plurality of photosensitive elements being disposed on the upper surface, the photosensitive elements being capable of converting incident radiation to electrical signals,
an optically receptive stacked layer formed on the upper surface, the optically receptive stacked layer comprising a lens layer of material having an index of refraction n_{L}, which is formed into a layer of converging microlenses and further comprising optical layers disposed between the microlenses and the upper surface of the semiconductor substrate, and
an intermediate optically refractive layer of index of refraction n_{I} and thickness t_{I} formed on the microlenses, a lower surface of the intermediate layer being conformally in contact with the microlenses and an upper surface of the layer being planar; and
first and second packaging layers being bonded to the image sensor, the first packaging layer being a optically transparent substrate, the first packaging layer formed above and bonded to the intermediate optically refractive layer by a transparent bonding material having an index of refraction n_{B}, the second packaging layer formed below and bonded to the lower surface of the semiconductor substrate by another bonding material.

33. The packaged image sensor of claim 32, further comprising a plurality of solder connectors disposed on the second packaging layer opposite to the semiconductor substrate, the solder connectors being connected between the image sensor and an external circuitry.

34. The packaged image sensor of claim 32, wherein the microlenses have radius of curvature between approximately 0.5 and 20 μm.

35. The packaged image sensor of claim 32, wherein the intermediate optically refractive layer has the thickness, t_{I}, higher than that of the microlens and has the index of refraction, n_{I}, smaller than the index of refraction, n_{B}, of the transparent bonding material.

36. The packaged image sensor of claim 35, wherein the transparent bonding material between the first packaging layer and the intermediate optically refractive layer is an epoxy with an index of refraction n_{B} which equals approximately 1.5.

37. The packaged image sensor of claim 36, wherein the intermediate optically refractive layer has the index of refraction, n_{I}, between approximately 1.33 and 1.5.

38. The packaged image sensor of claim 37, wherein the microlenses have the index of refraction n_{L} which equals approximately 1.63, the optical layers comprise a transparent color filter layer and an IC stacked layer between the transparent color filter layer and the upper surface of the semiconductor substrate, the transparent color filter layer has a thickness between approximately 2 and 6 μm and an index of refraction n_{CF} approximately 1.51, and the IC stacked layer has a thickness between approximately 2 and 12 μm and an index of refraction n_{IC} approximately 1.51.

39. The packaged image sensor of claim 32, wherein the intermediate optically refractive layer has the thickness, t_{I}, higher than that of the microlens and a difference between the index of refraction n_{L} of the microlenses and the index of refraction n_{I} of the intermediate optically refractive layer, n_{L}−n_{I}, is greater than 0.2.

40. The packaged image sensor of claim 39, wherein the intermediate optically refractive layer has the index of refraction, n_{I}, between approximately 1.33 and 1.5.

41. The packaged image sensor of claim 40, wherein the microlenses have the index of refraction n_{L} which equals approximately 1.63.

42. The packaged image sensor of claim 41, wherein the transparent bonding material is an epoxy with an index of refraction n_{B} which equals approximately 1.5.

43. The packaged image sensor of claim 42, wherein the optical layers comprise a transparent color filter layer and an IC stacked layer between the transparent color filter layer and the upper surface of the semiconductor substrate, the transparent color filter layer has a thickness between approximately 2 and 6 μm and an index of refraction n_{CF} approximately 1.51, and the IC stacked layer has a thickness between approximately 2 and 12 μm and an index of refraction n_{IC} approximately 1.51.

44. A device comprising a packaged image sensor of claim 32 embedded therein.

45. A packaged image sensor with improved sensitivity comprising:
an image sensor including
a semiconductor substrate having an upper surface and a lower surface, a plurality of photosensitive elements being disposed on the upper surface, the photosensitive elements being capable of converting incident radiation to electrical signals,
an optically receptive stacked layer formed on the upper surface, the optically receptive stacked layer comprising a lens layer of material having an index of refraction n_{L}, which is formed into a layer of converging microlenses and further comprising optical layers disposed between the microlenses and the upper surface, and
optically transparent packaging layers formed above the microlenses and below the lower surface of the sensing device; and
first and second packaging layers being bonded to the image sensor, the first packaging layer being a optically transparent substrate, the first packaging layer formed above and bonded to the microlenses by a transparent bonding material having an index of refraction n_{B}, the second packaging layer formed below and bonded to the lower surface of the semiconductor substrate by another bonding material, the transparent bonding material between the first packaging layer and the microlenses having an index of refraction n_{B}, a difference between the index of refraction n_{L} of the microlenses and the index of refraction n_{B} of the transparent bonding material, n_{L}−n_{B}, being greater than 0.2 to focus incident radiation on the photosensitive elements.

46. The packaged image sensor of claim 45, further comprising a plurality of solder connectors disposed on the packaging layer bonding to the lower surface of the semiconductor substrate and opposite to the semiconductor substrate, the solder connectors being connected between the image sensor and an external circuitry.

47. The packaged image sensor of claim 45, wherein the index of refraction n_{L} of the microlenses equals approximately 1.63.

48. The packaged image sensor of claim 47, wherein the transparent bonding material is an epoxy with an index of refraction n_{B} which is between approximately 1.33 and 1.45.

49. The packaged image sensor of claim 58, wherein the index of refraction n_{L} of the microlenses is between approximately 1.73 and 1.8.

50. A device comprising a packaged image sensor of claim 54 embedded therein.
